(19) United States
(12) Patent Application Publication
(10) Pub. No.: US 2025/0306725 A1
(43) Pub. Date: Oct. 2, 2025

(54) METHOD, APPARATUS, DEVICE AND STORAGE MEDIUM FOR CONTENT PRESENTATION

(71) Applicants: Lemon Inc., Grand Cayman (KY); Beijing Zitiao Network Technology Co., Ltd., Beijing (CN)

(72) Inventors: Tianhao He, Culver City, CA (US); Xin Wang, Beijing (CN)

(21) Appl. No.: 19/097,031

(22) Filed: Apr. 1, 2025

Related U.S. Application Data
(63) Continuation of application No. PCT/CN2024/085382, filed on Apr. 1, 2024.

(51) Int. Cl. G06F 3/0481; G06F 3/0484

(52) U.S. Cl. CPC G06F 3/0481; G06F 3/0484

(57) ABSTRACT

Embodiments of the disclosure relate to a method, an apparatus, a device and a storage medium for content presentation. The method proposed herein includes: in response to a predetermined operation by a first user, displaying a target interface associated with the first user; and displaying a first content component corresponding to a second user in the target interface, the first content component displaying description information about the second user and at least one work of the second user, where, the first content component includes a plurality of predetermined areas for presenting different works, each predetermined area includes an image area and a text area, the image area is configured to present image content of a corresponding work, and the text area is configured to present text content of the corresponding work. In this way, the embodiments of the disclosure can improve the efficiency of content acquisition.

### CROSS REFERENCE

The application claims priority to PCT Patent Application No. PCT/CN2024/085382, filed on Apr. 1, 2024, and entitled “METHOD, APPARATUS, DEVICE AND STORAGE MEDIUM FOR CONTENT PRESENTATION”, the entirety of which is incorporated herein by reference.

### FIELD

Example embodiments of the present disclosure relate generally to the field of computers, and in particular to a method, an apparatus, a device and a computer-readable storage medium for content presentation.

### BACKGROUND

In recent years, with development of the Internet, more and more people are publishing or browsing works on online platforms. However, in existing network platforms, when presenting to a user relevant information of other users, the page content is too simple and cannot meet people's information acquisition needs.

### SUMMARY

In a first aspect of the present disclosure, a method of content presentation is provided. The method includes: in response to a predetermined operation of the first user, displaying a target interface associated with the first user; and displaying a first content component corresponding to the second user in the target interface, the first content component displaying information about the second user description information and at least one work of the second user, where the first content component includes a plurality of predetermined areas for displaying different works, each predetermined area includes an image area and a text area, and the image area is used for displaying images of the corresponding works. Content, the text area is used to display the text content of the corresponding work.

In a second aspect of the present disclosure, an apparatus for content presentation is provided. The apparatus includes: a displaying module configured to display a target interface associated with the first user in response to a predetermined operation by the first user; a content module configured to display first content corresponding to the second user in the target interface component, the first content component displays descriptive information about the second user and at least one work of the second user, where the first content component includes a plurality of predetermined areas for displaying different works, and each predetermined area includes an image area and text Area, the image area is used to display the image content of the corresponding work, and the text area is used to display the text content of the corresponding work.

In a third aspect of the present disclosure, an electronic device is provided. The device includes at least one processing unit; and at least one memory coupled to the at least one processing unit and storing instructions for execution by the at least one processing unit. The instructions, when executed by at least one processing unit, cause the device to perform the method of the first aspect.

In a fourth aspect of the present disclosure, a computer-readable storage medium is provided. A computer program is stored on the computer-readable storage medium, and the computer program can be executed by a processor to implement the method of the first aspect.

It should be understood that what is described in this content section is not intended to limit key features or important features of the embodiments of the present disclosure, nor is it intended to limit the scope of the present disclosure. Other features of the present disclosure will become apparent from the description below.

### BRIEF DESCRIPTION OF THE DRAWINGS

The above and other features, advantages and aspects of various embodiments of the present disclosure will become more apparent with reference to the following detailed description taken in conjunction with the accompanying drawings. In the drawings, the same or similar reference numbers represent the same or similar elements, where:

FIG. 1 illustrates a schematic diagram of an example environment capable of implement some embodiments of the present disclosure;

FIGS. 2A-2B illustrate example interfaces according to some embodiments of the present disclosure;

FIG. 3 illustrates a flowchart of an example process for content presentation according to some embodiments of the present disclosure;

FIG. 4 illustrates a schematic structural block diagram of an example apparatus for content presentation according to some embodiments of the present disclosure; and

FIG. 5 illustrates a block diagram of an electronic device capable of implementing a plurality of embodiments of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as limited to the embodiments set forth herein, but rather, these embodiments are provided for a thorough and complete understanding of this present disclosure. It should be understood that the drawings and embodiments of the present disclosure are for illustrative purposes only and are not intended to limit the scope of the present disclosure.

It is important to note that heading of any section/subsection provided in this article is not limiting. Various embodiments are described throughout herein, and any type of embodiments can be included under any section/subsection. Furthermore, the embodiments described in any section/subsection may be combined in any way with any other embodiments described in the same section/subsection and/or in a different section/subsection.

In the description of embodiments of the present disclosure, the term “including/comprising” and similar expressions shall be understood as an open-ended inclusion, that is, “including but not limited to”. The term “based on” should be understood to mean “based at least in part on.” The term “an embodiment” or “the embodiment” shall be understood to mean “at least one embodiment”. The term “some embodiments” should be understood as “at least some embodiments”. Other explicit and implicit definitions may be included below. The terms “first”, “second”, etc. may refer to different or the same object. Other explicit and implicit definitions may be included below.

The embodiments of the present disclosure may involve user data, the obtaining and/or use of data, etc. These aspects comply with corresponding laws, regulations and relevant regulations. In the embodiments of this disclosure, collection, obtaining, processing, processing, forwarding, use, etc. of all data are performed with the user's knowledge and confirmation. Accordingly, when implementing each embodiment of the present disclosure, users should be informed of the type, scope of use, usage scenarios, etc. that may be involved in the data or information and obtain their authorization through appropriate means in accordance with relevant laws and regulations. The specific notification and/or authorization methods may vary according to the actual situation and application scenarios, and the scope of the present disclosure is not limited in this regard.

The technical solution in this specification and embodiments, if the processing of personal information is involved, the processing will be carried out on the premise that there is a basis of legality (e.g., consent of the subject of the personal information is obtained or it is necessary to fulfill a contract, etc.), and the processing will be carried out only within the scope of the stipulations or agreements. The user refusing to process personal information other than that which is necessary for the basic functions will not affect the user's use of the basic functions.

As mentioned briefly above, in the process of using the network platform, a user needs to follow more users or browse more related works in order to meet his/her browsing needs. However, in the existing network platform, the display content of traditional pages is too single, making it difficult to provide users with sufficient information, thus affecting the user's information acquisition efficiency.

The embodiments of the present disclosure propose a solution for content presentation. According to this solution, a target interface associated with the first user can be displayed in response to a predetermined operation by the first user; and a first content component corresponding to a second user is displayed in the target interface, and the first content component displaying description information about the second user and at least one work of the second user. The first content component includes a plurality of predetermined areas for presenting different works, each predetermined area includes an image area and a text area, and the image area is configured to present image content of a corresponding work, and the text area is configured to present text content of the corresponding work.

In this way, the embodiments of the present disclosure can provide graphic and text information of other users' works on the page, thereby helping the current user understand other users more efficiently. Therefore, the embodiments of the present disclosure can improve the efficiency of information presentation and information acquisition.

Various example implementations of this solution are further described in detail below with reference to the accompanying drawings.

### Example Environment

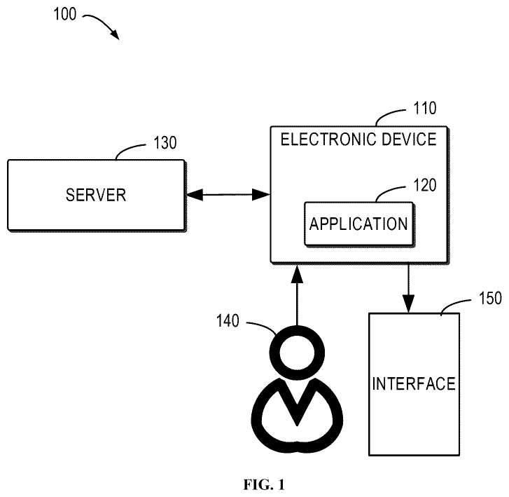

FIG. 1 illustrates a schematic diagram of an example environment 100 in which embodiments of the present disclosure can be implemented. As shown in FIG. 1, example environment 100 may include electronic device 110.

In this example environment 100, an application 120 that supports interface interaction may run on an electronic device 110. The application 120 may be any suitable type of application for interface interaction, examples of which may include but are not limited to: a video application, a music application, or other appropriate applications. A user 140 may interact with application 120 via the electronic device 110 and/or its attached devices.

In the environment 100 of FIG. 1, if the application 120 is in an active state, the electronic device 110 may display an interface 150 for supporting interface interaction through the application 120.

In some embodiments, the electronic device 110 communicates with the server 130 to enable provision of services to the application 120. The electronic device 110 may be any type of a mobile terminal, a fixed terminal or a portable terminal, including a mobile phone, a desktop computer, a laptop computer, a notebook computer, a netbook computer, a tablet computer, a media computer, a multimedia tablet, a palmtop computer, a portable game terminal, a VR/AR equipment, a Personal Communication System (PCS) device, a personal navigation device, a Personal Digital Assistant (PDA), an audio/video player, a digital cameras/camcorder, a positioning device, a TV receiver, a radio receiver, an e-book device, a gaming device, or any combination of the foregoing, including accessories and peripherals for these devices or any combination thereof. In some embodiments, the electronic device 110 can also support any type of interface targeted to the user (such as “wearable” circuitry, etc.).

The server 130 may be an independent physical server, or a server cluster or distributed system consisted of a plurality of physical servers, or a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the applications 120 in the electronic device 110 that support virtual scenario.

A communication connection may be established between the server 130 and the electronic device 110. Communication connections can be established via wired or wireless manner. Communication connections may include but are not limited to Bluetooth connections, mobile network connections, Universal Serial Bus (USB) connections, Wireless Fidelity (WIFI) connections, etc. The embodiments of the present disclosure are not limited in this regard. In the embodiments of the present disclosure, the server 130 and the electronic device 110 can implement signaling interaction through the communication connection therebetween.

It should be understood that the structure and function of various elements in environment 100 are described for illustrative purposes only and do not imply any limitation on the scope of the present disclosure.

Some example embodiments of the present disclosure will continue to be described below with reference to the accompanying drawings.

### Example Interaction

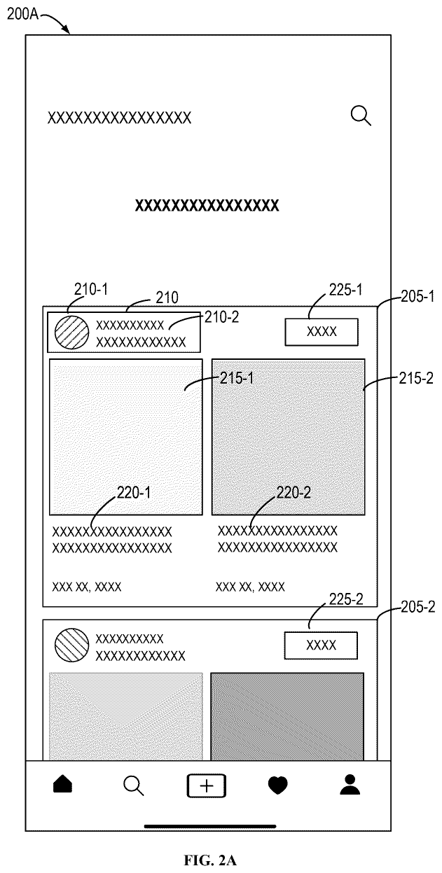

FIG. 2A-2B illustrate example interfaces 200A-200B according to some embodiments of the present disclosure. The interfaces 200A to 200B may be provided by the electronic device 110 shown in FIG. 1, for example.

In some embodiments, the electronic device 110 may present a target interface 200A associated with the first user as shown in FIG. 2A in response to a predetermined operation by a user (also referred to as a first user).

As an example, the electronic device 110 may receive the user's selection of the access entry of the target interface 200A, and then present the interface 200A as shown in FIG. 2A. Alternatively, the electronic device 110 may also present such an interface 200A by default based on the user's request to open the application 120.

In some embodiments, as shown in FIG. 2A, the electronic device 110 may provide content components corresponding to the second user (e.g., other users in the application platform except the first user) in the target interface 200A, for example, the content component 205-1 and content component 205-2 (individually or collectively referred to as the content component 205). In some embodiments, the second user may be a user that satisfies a predetermined relationship condition with the first user, for example, a user that the first user has not yet followed.

As shown in FIG. 2A, the content component 205-1 and the content component 205-2 may correspond to different users. Taking the content component 205-1 as an example, the content component 205-1 may be used to present information associated with the second user.

In some embodiments, the electronic device 110 may display description information 210 about the second user in the content component 205-1. As shown in FIG. 2A, the description information 210 may include an image identification 210-1 (for example, the avatar of the second user) and/or a text identification 210-2 (for example, a nickname and/or a brief introduction of the second user) of the second user.

In some embodiments, the electronic device 110 may also display at least one work of the second user in the content component 205-1. As shown in FIG. 2A, as an example, the electronic device 110 may provide a plurality of predetermined areas for presenting different works in the content component 205, and each predetermined area may include an image area and a text area.

Specifically, the image area may present image content of the corresponding work of the second user, for example, a specific image or a part of the image, a video frame, a video clip, etc. in the work. The text area may present text content of the corresponding work of the second user, for example, the text part of the work, the description text of the work, etc.

In some embodiments, the work presented in the content component 205-1 may be a graphic and text work, the image content may be an image in the graphic and text work, and the text content may be text in the graphic and text work.

As an example, as shown in FIG. 2A, the content component 205-1 may include two predetermined areas. The two predetermined areas respectively include an image area 215-1 and an image area 215-2 (individually or collectively referred to as the image area 215), and a text area 220-1 and a text area 220-2 (individually or collectively referred to as the text area 220).

It should be understood that the specific number and arrangement of the predetermined areas shown in FIG. 2A are only exemplary and are not intended to limit the present disclosure.

As an example, as shown in FIG. 2A, the electronic device 110 presents image content of a first work of the second user in the image area 215-1 of the content component 205-1, and presents text content of the first work in the text area 220-1. In addition, the electronic device 110 presents image content of a second work of the second user in the image area 215-2 of the content component 205-1, and presents the text content of the second work in the text area 220-2.

In some embodiments, the image area 215 and the content area 220 may have predetermined sizes. If image content of a corresponding work does not match the size, the electronic device 110 may fill part of the image area 215 with the image content or crop the image content to match the image area 215.

For the content area 220, if the text content of the work exceeds the display size, the electronic device 110 may only display part of the text content in the text area 220. On the contrary, if the text content does not exceed the display size, the electronic device 110 may display the entire text content in the text area 220.

In some embodiments, when the electronic device 110 displays in the content component 205 that at least one work of the second user is a work without pictures (such as music or plain text), the image area 215 may not display pictures or display a predetermined picture. The predetermined picture can be a platform-customized picture or a related picture generated based on a music work or a plain text work. The present disclosure does not limit the specific content of the predetermined picture.

In some embodiments, the electronic device 110 may also receive the first user's predetermined operation for the content component 205 and stop presenting the content component 205 in the target interface 200A. As an example, the predetermined operation may be a predetermined sliding operation (for example, a left sliding operation for a predetermined area of the content component 205-1), a click operation (such as clicking the close button in the content component 205-1), a long press operation, etc.

In some embodiments, the electronic device 110 may also display prompt information after receiving the first user's predetermined operation on the content component 205. As an example, the prompt information may include two controls: like and uninterested. Further, the electronic device 110 may continue to display or stop displaying the content component 205 in the target interface 200A in response to the first user's triggering of the like control or the uninterested control. In addition, the electronic device 110 may also establish a predetermined association between the first user and the second user in response to the first user's triggering of the like control, for example, the second user is added as a following user of the first user.

In some embodiments, the electronic device 110 may receive a predetermined operation for the content component 205 and display at least one other work of the second user in the content component 205 accordingly. As an example, the predetermined operation may include a left and right sliding operation within a designated area in the content component 205-1.

For example, the content component 205-1 may initially display two works of the second user. Further, the electronic device 110 may receive the user's left sliding operation on the image area or text area of the content component 205, and then display at least one other work of the second user.

As an example, the electronic device 110 may move the work displayed in the right side of the predetermined area to be displayed in the left side of the predetermined area based on the sliding operation, and display another work of the second user in the right side of the predetermined area. As another example, the electronic device 110 may also switch the two predetermined areas to display two other works of the second user at the same time based on the sliding operation.

As yet another example, such a predetermined area may also move accordingly following the sliding operation. For example, when a left sliding operation is received, the left side of the predetermined area may be partially hidden following the sliding operation until presentation is stopped. Correspondingly, another predetermined area may be presented in the content component 205-1 following the sliding operation to display another work of the second user.

In some embodiments, continuing to refer to FIG. 2A, the electronic device 110 may also present a viewing interface for the work associated with the image area 215 or the text area 220 according to the first user's selection of the image area 215 or the text area 220. As an example, the viewing interface of the work can be the playback page of the corresponding work, and the playback page can present or play the complete content of the work.

In some embodiments, continuing to refer to FIG. 2A, the electronic device 110 may also display a viewing interface of the second user associated with the description information 210 according to the selection of the description information 210 by the first user. As an example, the viewing interface may be a personal page of the second user, and the personal page may present basic information of the second user, related works of the second user, etc.

In some embodiments, the target interface 200A can be configured to present the interactive information of the first user. In some embodiments, when it is determined that the interactive information satisfies the predetermined condition, the electronic device 110 may display the content component 205 as shown in FIG. 2A in the target interface 110 accordingly. It should be understood that the acquisition and use of such interactive information can be performed with the user's knowledge and permission.

As an example, the interactive information may be related to a predetermined interaction behavior of the first user. For example, the interactive information may include the first user's following information, favorite information, like information, and so on.

Taking the interactive information including following information as an example, the electronic device 110 may, for example, trigger the presentation of content components 205 corresponding to other users not followed by the first user in the interface 200A, when it is determined that the number of following users of the first user is less than a threshold.

In some embodiments, such content components 205 may also provide interactive controls corresponding to the predetermined interactive behavior, for example, an interactive control 225-1 and an interactive control 225-2. Upon receiving the triggering of the interactive control 225-1, the electronic device 110 may initiate a predetermined interactive behavior for the second user, for example, adding following to the second user.

The display and interactive solution of the content component 205 has been introduced above, and the solution of determining the presentation of the works presented in the content component 205 will be further introduced below.

In some embodiments, the works presented in the content component 205 may be determined based on a work attribute of each work in the second user's work collection. Such work attribute may include, for example, the publishing time of the work, the category of the work, the tag of the work, etc. For example, the works presented in the content component 205 may be works published by the second user within a predetermined period.

In some embodiments, a work presented in the content component 205 may be determined based on the interactive information of each work in the work collection of the second user. Such interactive information may include, for example, browsing information, like information, comment information, etc. of the work. The popularity of each work can be determined based on such interactive information, and a work whose popularity is greater than a threshold is selected to be presented in the corresponding content component 205.

In some embodiments, the work presented in the content component 205 can also be determined based on the reference information of the first user, so that the content component corresponding to the second user and viewed by different users may present different works.

It should be understood that the above work attributes, interactive information and reference information are acquired and used with the knowledge and permission of the corresponding users.

In some embodiments, the work presented in the content component 205 may also be determined based on the corresponding configuration operation of the second user. For example, the second user may configure the work that other users can view via the content component 205.

Additionally, the second user may also configure the display style of the corresponding content component 205, for example. For example, the second user may instruct the arrangement of each work in the content component 205, and the background style, layout structure, etc. of the content component.

Therefore, the embodiments of the present disclosure can support users to customize corresponding content components to better express the user's personal preferences.

In some embodiments, the electronic device 110 may also provide other content components in the interface that are different from the content component 205 discussed above. As shown in FIG. 2B, the electronic device 110 may display the content component 230 corresponding to the third user in the target interface 200B.

As shown in FIG. 2B, the content component 230 may have a different layout style than the content component 205. Specifically, the content component 230 may, for example, present description information of the third user without presenting the work of the third user.

For example, the electronic device 110 may present image description information 235-1 and text description information 235-2 (collectively referred to as description information 235) of the third user in the content component 230 in different layouts. In some embodiments, such text description information 235-2 may include, for example, recommendation reasons for presenting a content component of the third user, thereby helping the user decide whether to perform the corresponding interactive action for the third user.

Based on the process described above, the embodiments of the present disclosure can provide graphic and text information of other users' works on the page, thereby helping the current user understand other users more efficiently. Therefore, the embodiments of the present disclosure can improve the efficiency of information presentation and information acquisition.

### Example Process

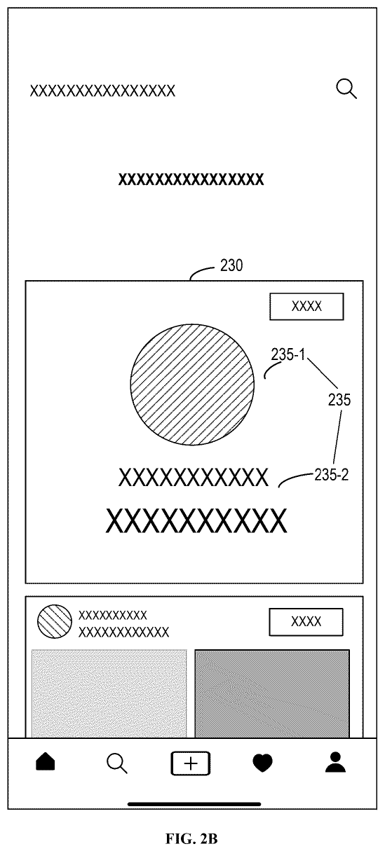

FIG. 3 illustrates a flowchart of an example process 300 for content presentation according to some embodiments of the present disclosure. The process 300 may be implemented at the electronic device 110. The process 300 is described below with reference to FIG. 1.

As shown, at block 310, the electronic device 110 displays a target interface associated with the first user in response to a predetermined operation by a first user.

At block 320, a first content component corresponding to the second user is displayed in the target interface, the first content component displays description information about the second user and at least one work of the second user, where the first content component includes a plurality of predetermined areas for presenting different works. Each predetermined area includes an image area and a text area. The image area is configured to present image content of a corresponding work, and the text area is configured to present text content of the corresponding work.

In some embodiments, the target interface is configured to present interactive information of the first user, and displaying the first content component corresponding to the second user in the target interface includes: in response to the interactive information satisfying a predetermined condition, displaying the first content component corresponding to the second user in the target interface.

In some embodiments, the interactive information is associated with a target interactive action, and the first content component provides controls for initiating the targeted interactive action with the second user.

In some embodies, at least one work is determined from a work collection of the second user based on at least one of the following information: a work attribute of each work in the work collection of the second user, interactive information of each work in the work collection of the second user, or reference information associated with the first user.

In some embodiments, the method 300 further includes: receiving a first operation for the first content component; and stopping presenting the first content component in the target interface.

In some embodiments, the method 300 further includes: receiving a second operation for the first content component; and displaying at least one other work of the second user in the first content component based on the second operation.

In some embodiments, the method 300 further includes: presenting a first viewing interface of the corresponding work based on a selection of the image area or the text area, or displaying a second viewing interface of the second user based on a selection of the description information.

In some embodiments, the display style of the first content component and/or the at least one work presented in the first content component is determined based on a configuration operation by the second user.

In some embodiments, the method 300 further includes: displaying a second content component corresponding to a third user in the target interface, the second content component having a layout style different from that of the first content component, and the second content component presenting description information of the third user but not presenting a work of the third user.

In some embodiments, the text area has a predetermined display size, and the method further includes: in response to the text content exceeding the display size, displaying a portion of the text content in the text area. or in response to the text content not exceeding the display size, displaying the text content in the text area.

### Example Apparatus and Device

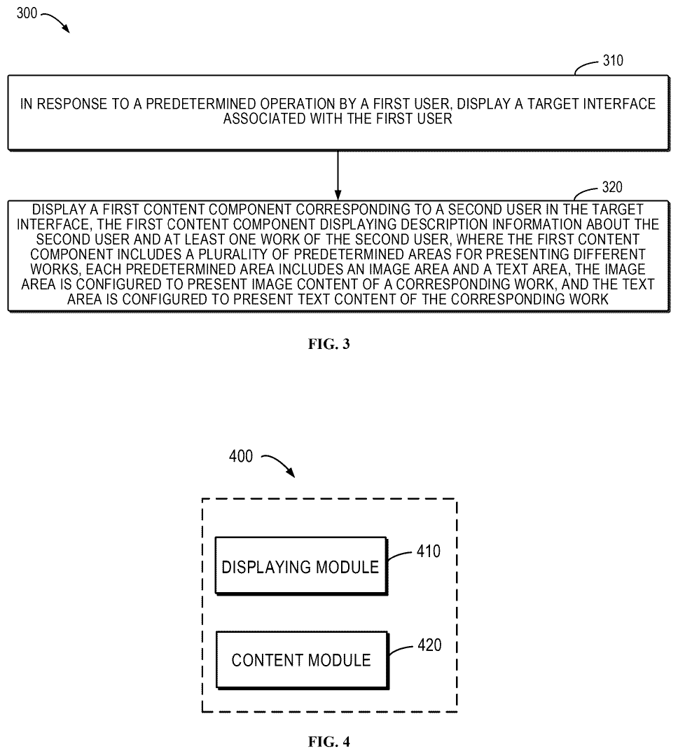

Embodiments of the present disclosure also provide a corresponding apparatus for implementing the above methods or processes. FIG. 4 illustrates a schematic structural block diagram of an example apparatus 400 for configuring a plug-in according to certain embodiments of the present disclosure. The apparatus 400 may be implemented as or included in an electronic device. Each module/component in the device 400 may be implemented by hardware, software, firmware, or any combination thereof.

As shown in FIG. 4, the apparatus 400 includes a displaying module 410 configured to display a target interface associated with the first user in response to a predetermined operation by the first user; and a content module 420 configured to display a first content component corresponding to a second user in the target interface. The first content component displays description information about the second user and at least one work of the second user, where the first content component includes a plurality of predetermined areas for presenting different works, each predetermined area includes an image area and a text area. The image area is configured to present the image content of the corresponding work, and the text area is configured to present text content of the corresponding work.

In some embodiments, the display module 410 is further configured such that: the target interface is configured to present interactive information of the first user, and displaying the first content component corresponding to the second user in the target interface includes: in response to the interactive information satisfying a predetermined condition, displaying the first content component corresponding to the second user in the target interface.

In some embodiments, the content module 420 is further configured such that: the interactive information is associated with a target interactive action, and the first content component provides a control for initiating the target interactive action with the second user.

In some embodiments, the content module 420 is further configured such that: the at least one work is determined from a work collection of the second user based on at least one of the following information: a work attribute of each work in the work collection of the second user, interactive information of each work in the work collection of the second user, or reference information associated with the first user.

In some embodiments, the content module 420 is further configured to: receive a first operation for the first content component; and stop rendering the first content component in the target interface.

In some embodiments, the content module 420 is further configured to: receive a second operation for the first content component; and display at least one other work of the second user in the first content component based on the second operation.

In some embodiments, the content module 420 is further configured to: present a first viewing interface of the corresponding work based on a selection of the image area or the text area, or display a second viewing interface of the second user based on a selection of the description information.

In some embodiments, the content module 420 is further configured such that: the display style of the first content component and/or the at least one work presented in the first content component is determined based on a configuration operation by the second user.

In some embodiments, the content module 420 is further configured to: display a second content component corresponding to a third user in the target interface, the second content component has a layout style different from that of the first content component, and the second content component presents description information of the third user but not present a work of the third user.

In some embodiments, the content module 420 is further configured such that the text area has a predetermined display size, and the device 400 further includes a text display module configured to: in response to the text content exceeding the display size, display a portion of the text content in the text area, or in response to the text content not exceeding the display size, display the text content in the text area.

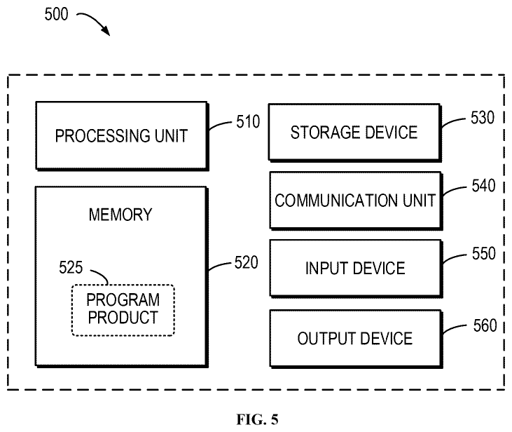

FIG. 5 illustrates a block diagram of an electronic device 500 in which one or more embodiments of the present disclosure may be implemented. It should be understood that the electronic device 500 shown in FIG. 5 is merely exemplary and should not constitute any limitation on the functionality and scope of the embodiments described herein. The electronic device 500 shown in FIG. 5 may be used as the electronic devices.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve the parallel processing capability of electronic device 500.

The electronic device 500 typically includes a plurality of computer storage media. Such media may be any available media accessible by the electronic device 500, including, but not limited to, volatile and non-volatile media, removable and non-removable media. The memory 520 may be a volatile memory (e.g., a register, a cache, a random-access memory (RAM)), a non-volatile memory (e.g., read-only memory (ROM), an electrically erasable programmable read-only memory (EEPROM), flash memory), or some combination thereof. A storage device 530 may be a removable or non-removable medium and may include a machine-readable medium, such as a flash drive, a magnetic disk, or any other medium, which may be used to store information and/or data and may be accessed within the electronic device 500.

The electronic device 500 may further include additional removable/non-removable, volatile/non-volatile storage media. Although not shown in FIG. 5, a disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communications unit 540 implements communications with other electronic devices over a communications medium. Additionally, the functionality of components of the electronic device 500 may be implemented in a single computing cluster or a plurality of computing machines capable of communicating over a communication connection. Thus, the electronic device 500 may operate in a networked environment using logical connections to one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) such as a storage device, a display device, or the like through the communication unit 540 as required, and communicate with one or more devices that enable a user to interact with the electronic device 500, or communicate with any device (e. g., a network card, a modem, or the like) that enables the electronic device 500 to communicate with one or more other electronic devices. Such communication may be performed via an input/output (I/O) interface (not shown).

According to exemplary implementations of the present disclosure, there is provided a computer-readable storage medium having computer instructions stored thereon, where the computer instructions are executed by a processor to implement the method described above. In accordance with exemplary implementations of the present disclosure, there is also provided a computer program product, and the computer program product is tangibly stored on a non-transient computer-readable medium and includes computer-executable instructions, and the computer-executable instructions are executed by the processor to implement the above-described method.

Aspects of the present disclosure are described herein with reference to flowcharts and/or block diagrams of methods, apparatuses, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may also be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some replaced implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/we claim:

1. A method of content presentation, comprising:
in response to a predetermined operation by a first user, displaying a target interface associated with the first user; and
displaying a first content component corresponding to a second user in the target interface, the first content component displaying description information about the second user and at least one work of the second user, wherein
the first content component comprises a plurality of predetermined areas for presenting different works, each predetermined area comprises an image area and a text area, the image area is configured to present image content of a corresponding work, and the text area is configured to present text content of the corresponding work.

2. The method of claim 1, wherein the target interface is configured to present interactive information of the first user, and displaying the first content component corresponding to the second user in the target interface comprises:
in response to the interactive information satisfying a predetermined condition, displaying the first content component corresponding to the second user in the target interface.

3. The method of claim 2, wherein the interactive information is associated with a target interactive action, and the first content component provides a control for initiating the target interactive action with the second user.

4. The method of claim 1, wherein the at least one work is determined from a work collection of the second user based on at least one of the following information:
a work attribute of each work in the work collection of the second user,
interactive information of each work in the work collection of the second user, or
reference information associated with the first user.

5. The method of claim 1, further comprising:
receiving a first operation for the first content component; and
stopping presenting the first content component in the target interface.

6. The method of claim 1, further comprising:
receiving a second operation for the first content component; and
displaying at least one other work of the second user in the first content component based on the second operation.

7. The method of claim 1, further comprising:
presenting a first viewing interface of the corresponding work based on a selection of the image area or the text area, or
displaying a second viewing interface of the second user based on a selection of the description information.

8. The method of claim 1, wherein a display style of the first content component and/or the at least one work presented in the first content component is determined based on a configuration operation by the second user.

9. The method of claim 1, further comprising:
displaying a second content component corresponding to a third user in the target interface, the second content component having a layout style different from that of the first content component, and the second content component presenting description information of the third user but not presenting a work of the third user.

10. The method of claim 1, wherein the text area has a predetermined display size, and the method further comprises:
in response to the text content exceeding the display size, displaying a portion of the text content in the text area, or
in response to the text content not exceeding the display size, displaying the text content in the text area.

11. An electronic device, comprising:
at least one processing unit; and
at least one memory coupled to the at least one processing unit and storing instructions for execution by the at least one processing unit, the instructions, when executed by the at least one processing unit, causes the electronic device to perform acts comprising:
in response to a predetermined operation by a first user, displaying a target interface associated with the first user; and
displaying a first content component corresponding to a second user in the target interface, the first content component displaying description information about the second user and at least one work of the second user, wherein
the first content component comprises a plurality of predetermined areas for presenting different works, each predetermined area comprises an image area and a text area, the image area is configured to present image content of a corresponding work, and the text area is configured to present text content of the corresponding work.

12. The electronic device of claim 11, wherein the target interface is configured to present interactive information of the first user, and displaying the first content component corresponding to the second user in the target interface comprises:
in response to the interactive information satisfying a predetermined condition, displaying the first content component corresponding to the second user in the target interface.

13. The electronic device of claim 12, wherein the interactive information is associated with a target interactive action, and the first content component provides a control for initiating the target interactive action with the second user.

14. The electronic device of claim 11, wherein the at least one work is determined from a work collection of the second user based on at least one of the following information:
a work attribute of each work in the work collection of the second user,
interactive information of each work in the work collection of the second user, or
reference information associated with the first user.

15. The electronic device of claim 11, wherein the acts further comprise:
receiving a first operation for the first content component; and
stopping presenting the first content component in the target interface.

16. The electronic device of claim 11, wherein the acts further comprise:
receiving a second operation for the first content component; and
displaying at least one other work of the second user in the first content component based on the second operation.

17. The electronic device of claim 11, wherein the acts further comprise:
presenting a first viewing interface of the corresponding work based on a selection of the image area or the text area, or
displaying a second viewing interface of the second user based on a selection of the description information.

18. The electronic device of claim 11, wherein a display style of the first content component and/or the at least one work presented in the first content component is determined based on a configuration operation by the second user.

19. The electronic device of claim 11, wherein the acts further comprise:
displaying a second content component corresponding to a third user in the target interface, the second content component having a layout style different from that of the first content component, and the second content component presenting description information of the third user but not presenting a work of the third user.

20. A non-transitory computer-readable storage medium having a computer program stored thereon, the computer program being executable by a processor to implement acts comprising:
in response to a predetermined operation by a first user, displaying a target interface associated with the first user; and
displaying a first content component corresponding to a second user in the target interface, the first content component displaying description information about the second user and at least one work of the second user, wherein
the first content component comprises a plurality of predetermined areas for presenting different works, each predetermined area comprises an image area and a text area, the image area is configured to present image content of a corresponding work, and the text area is configured to present text content of the corresponding work.
